(19) United States
(12) Patent Application Publication
(10) Pub. No.: US 2017/0364280 A1
(43) Pub. Date: Dec. 21, 2017

(54) OBJECT STORAGE DEVICE AND AN OPERATING METHOD THEREOF

(71) Applicant: SAMSUNG ELECTRONICS CO., LTD., SUWON-SI (KR)

(72) Inventor: HANJOON KIM, NAMYANGJU-SI (KR)

(21) Appl. No.: 15/593,719

(22) Filed: May 12, 2017

(30) Foreign Application Priority Data
Jun. 15, 2016 (KR) 10-2016-0074735

(51) Int. Cl. G06F 3/06

(52) U.S. Cl. CPC G06F 3/0611; G06F 3/0659; G06F 3/0683

(57) ABSTRACT

A controller includes: an interface unit configured to receive an access request for object data; and an indexing unit configured to determine whether to divide the object data and, when the object data is divided, store a first portion of the object data in a first memory and a second portion of the object data in a first storage space and a second storage space, wherein the first and second storage spaces have a latency greater than a latency of the first memory.

### CROSS-REFERENCE TO RELATED APPLICATION

This application claims priority under 35 U.S.C. §119 to Korean Patent Application No. 10-2016-0074735, filed on Jun. 15, 2016, in the Korean Intellectual Property Office, the disclosure of which is incorporated by reference herein in its entirety.

### TECHNICAL FIELD

The present inventive concept relates to a storage device, and more particularly, to an object storage device or a key-value store and an operating method of the object storage device or the key-value store.

### DISCUSSION OF THE RELATED ART

Storage may refer to object-based storage or block-based storage depending on a data management unit. Object-based storage (e.g., ‘object storage’) identifies a storage structure for storing and managing data in the form of an object. The object, e.g., multimedia data such as a moving picture, an image, etc., a file, or the like, may be data having a random size. Object-based storage may be used to manage the object.

### SUMMARY

According to an exemplary embodiment of the present inventive concept, there is provided a controller including: an interface unit configured to receive an access request for object data; and an indexing unit configured to determine whether to divide the object data and, when the object data is divided, store a first portion of the object data in a first memory and a second portion of the object data in a first storage space and a second storage space, wherein the first and second storage spaces have a latency greater than a latency of the first memory.

According to an exemplary embodiment of the present inventive concept, there is provided a nonvolatile memory storage device including: a first memory having a first latency; first and second storage spaces having a second latency greater than the first latency; and a controller configured to determine whether to divide object data in response to an access request of the object data and, when the object data is divided into first and second portions, store the first portion in the first memory and the second portion in the first and second storage spaces.

According to an exemplary embodiment of the present inventive concept, there is provided an object cache server including: a processor; a power supply; a network device; and a first memory, first and second storage spaces each having a latency greater than a latency of the first memory; and a controller configured to determine whether to divide object data in response to an access request of the object data and, when the object data is divided, store a first portion of the object data in the first memory and a second portion of the object data in the first and second storage spaces.

According to an exemplary embodiment of the present inventive concept, there is provided a write method including: receiving a write request and object data; dividing the object data into first and second partial values when a size of the object data is greater than a threshold value; storing the first partial value in a first memory having a first latency; storing the second partial value sequentially in the first and second storage spaces, wherein each of the first and second storage spaces has a second latency greater than the first latency.

According to an exemplary embodiment of the present inventive concept, there is provided a write method including: receiving a write request and object data; writing the object data to a first memory having a first latency; determining a size of the object data; dividing the object data into a first partial value and a second partial value when the size of the object data exceeds a threshold value; and storing the second partial value to first and second storage spaces having a second latency greater than the first latency.

According to an exemplary embodiment of the present inventive concept, there is provided a read method including: receiving a read request and a key in a first period; indexing a storage address of object data according to the key in a second period; reading a first partial value of the object data from a first memory in a third period and transmitting the read first partial value in a fourth period; and reading a second partial value of the object data from one of a first storage space and a second storage space having a latency greater than a latency of the first memory in the fourth period, and transmitting the second partial value in a fifth period.

### BRIEF DESCRIPTION OF THE DRAWINGS

Exemplary embodiments of the present inventive concept will be more clearly understood from the following detailed description taken in conjunction with the accompanying drawings in which:

FIG. 1 illustrates a network system, according to an exemplary embodiment of the present inventive concept;

FIG. 2 is a block diagram of an object storage device, according to an exemplary embodiment of the present inventive concept;

FIG. 3 illustrates a first memory shown in FIG. 2 according to an exemplary embodiment of the present inventive concept;

FIG. 4 illustrates a second memory shown in FIG. 2 according to an exemplary embodiment of the present inventive concept;

FIG. 5 is a block diagram of the second memory shown in FIG. 2 according to an exemplary embodiment of the present inventive concept;

FIG. 6 is a block diagram of a controller shown in FIG. 2 according to an exemplary embodiment of the present inventive concept;

FIG. 7 illustrates operation performed by an indexing unit shown in FIG. 6 according to an exemplary embodiment of the present inventive concept;

FIG. 8 is a block diagram of the indexing unit shown in FIG. 6 according to an exemplary embodiment of the present inventive concept;

FIG. 9 is a block diagram of the controller shown in FIG. 2 according to an exemplary embodiment of the present inventive concept;

FIG. 10 is a flowchart of an operating method of an object storage device, according to an exemplary embodiment of the present inventive concept;

FIGS. 11, 12 and 13 illustrate a write operation with respect to the object storage device of FIG. 2, according to exemplary embodiments of the present inventive concept;

FIG. 14 is a flowchart illustrating operations between an application server and a cache server, according to an exemplary embodiment of the present inventive concept;

FIG. 15 is a flowchart of an operating method of an object storage device, according to an exemplary embodiment of the present inventive concept;

FIGS. 16 and 17 illustrate a read operation with respect to the object storage device shown in FIG. 2, according to exemplary embodiments of the present inventive concept;

FIG. 18A illustrates a read operation performed by the object storage device of FIG. 17, according to an exemplary embodiment of the present inventive concept;

FIG. 18B illustrates a read operation performed by an object storage device, according to a comparative example;

FIG. 19 is a flowchart illustrating operations between an application server and a cache server, according to an exemplary embodiment of the present inventive concept;

FIG. 20 is a block diagram of an object storage device, according to an exemplary embodiment of the present inventive concept;

FIG. 21 illustrates a write operation with respect to the object storage device of FIG. 20, according to an exemplary embodiment of the present inventive concept;

FIG. 22 illustrates a read operation with respect to the object storage device shown in FIG. 20, according to an exemplary embodiment of the present inventive concept;

FIG. 23 illustrates a read operation performed by the object storage device shown in FIG. 20, according to an exemplary embodiment of the present inventive concept;

FIG. 24 is a block diagram of an object storage device, according to an exemplary embodiment of the present inventive concept;

FIG. 25 illustrates a write operation with respect to the object storage device of FIG. 24, according to an exemplary embodiment of the present inventive concept;

FIG. 26 illustrates a read operation with respect to the object storage device of FIG. 24, according to an exemplary embodiment of the present inventive concept;

FIG. 27 illustrates a read operation performed by the object storage device shown in FIG. 24, according to an exemplary embodiment of the present inventive concept;

FIG. 28 is a block diagram of an object storage device, according to an exemplary embodiment of the present inventive concept;

FIG. 29 illustrates a write operation with respect to the object storage device of FIG. 28, according to an exemplary embodiment of the present inventive concept;

FIG. 30 illustrates a read operation with respect to the object storage device of FIG. 28, according to an exemplary embodiment of the present inventive concept; and

FIG. 31 is a block diagram of a computing system, according to an exemplary embodiment of the present inventive concept.

### DETAILED DESCRIPTION OF THE EMBODIMENTS

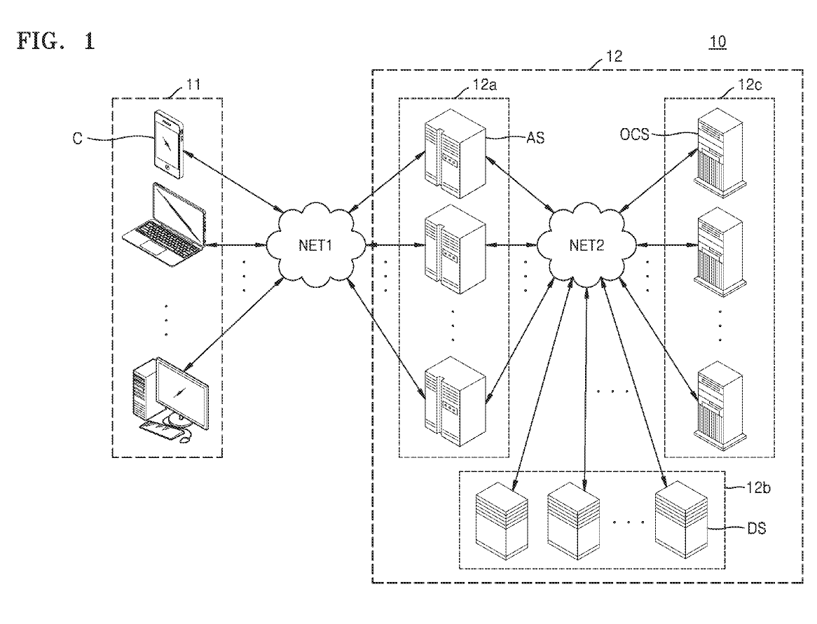

FIG. 1 illustrates a network system 10, according to an exemplary embodiment of the present inventive concept.

Referring to FIG. 1, the network system 10 may include a client group 11 and a data center 12. The client group 11 may include a plurality of client devices C, and the client devices C may communicate with the data center 12 via a first network NET1, e.g., the Internet. The client devices C may include various electronic devices such as a smart phone, a smart pad, a notebook computer, a personal computer, a smart camera, a smart television, or the like.

The data center 12 corresponds to a facility that collects various types of data and provides a service. The data center 12 may include an application server group 12a, a database server group 12b, and an object cache server group 12c. The application server group 12a, the database server group 12b, and the object cache server group 12c may communicate with each other via a second network NET2, e.g., a local area network (LAN) or an intranet.

The application server group 12a may include a plurality of application server devices AS. The application server devices AS may process a request received from the client group 11 via the first network NET1, and may access the database server group 12b or the object cache server group 12c according to a request from the client group 11. For example, the application server devices AS may store a plurality of items of data, which the client group 11 requested for storage, in the database server group 12b via the second network NET2, and may store, in the object cache server group 12c, some items of data stored in the database server group 12b. In addition, the application server devices AS may obtain data, which the client group 11 requested for reading, from the object cache server group 12c via the second network NET2, and when the requested data is not present in the object cache server group 12c, the application server devices AS may obtain data, which the client group 11 requested for reading, from the database server group 12b via the second network NET2.

The database server group 12b may include a plurality of database server devices DS. The database server devices DS may store data processed by the application server devices AS, and may provide, to the application server devices AS, data according to a request from the application server devices AS. Each of the database server devices DS may provide non-volatile large capacity storage.

The object cache server group 12c may include a plurality of object cache server devices OCS. The object cache server devices OCS temporarily store data stored in the database server devices DS or data read from the database server devices DS. This way, the object cache server devices OCS may function as a cache between the application server devices AS and the database server devices DS. The object cache server devices OCS may respond to a request received from the application server group 12a at a response speed faster than that of the database server devices DS. In this case, each of the object cache server devices OCS may provide high-speed storage.

According to the present embodiment, each object cache server device OCS may include heterogeneous memories. In the present embodiment, each object cache server device OCS may include a first memory having a first latency and a second memory having a second latency greater than the first latency. Each object cache server device OCS may perform read operations with respect to the first and second memories at one time, and may continuously perform the read operation with respect to the second memory while data read from the first memory having a fast response speed is transmitted.

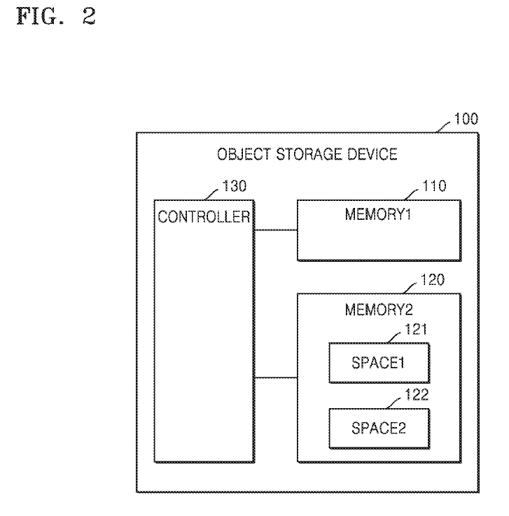

For example, in response to a write request received from one of the application server devices AS, an object cache server device OCS receives the write request and may store a head portion of an object in the first memory and may duplicately store a tail portion of the object in the second memory. The object cache server device OCS may perform read operations with respect to the first and second memories at one time in response to the write request from the application server device AS, may first transmit the head portion of the object which is read from the first memory having a fast read speed, and then, may transmit the tail portion of the object which is read from the second memory having a slow read speed. Accordingly, the object cache server device OCS may increase a storage capacity corresponding to a storage capacity of the second memory while the object cache server device OCS maintains its fast response speed. Hereinafter, with reference to FIGS. 2 through 30, various embodiments of the object cache server device OCS will be described in detail.

FIG. 2 is a block diagram of an object storage device 100, according to an exemplary embodiment of the present inventive concept.

Referring to FIG. 2, the object storage device 100 for managing data by units of objects may include a first memory 110, a second memory 120, and a controller 130. In the present embodiment, the object storage device 100 may be used as an object cache device or an object cache system. For example, the object storage device 100 may be the object cache server device OCS shown in FIG. 1. However, the inventive concept is not limited to the cache devices, and in an exemplary embodiment of the present inventive concept, the object storage device 100 may be used as any device or system which manages data by units of objects. In addition, in an exemplary embodiment of the present inventive concept, the object storage device 100 is not limited to a server device and may be embodied as a memory module or a storage module.

The first and second memories 110 and 120 may be heterogeneous memories having different hardware attributes. Each of the first and second memories 110 and 120 may be embodied as a memory chip. For example, the hardware attributes may include latency, memory bandwidth, memory power consumption, or the like. The latency may be a read latency, a write latency, a column address strobe (CAS) latency, a row address strobe (RAS) latency, and the like.

In the present embodiment, the first memory 110 may have a first latency, and the second memory 120 may have a second latency greater than the first latency. Therefore, the first memory 110 may have a response time shorter than that of the second memory 120. For example, the first memory 110 may include a dynamic random access memory (DRAM) or a phase-change random access memory (PRAM). For example, the second memory 120 may include a NAND flash memory or a hard disk drive.

In an exemplary embodiment of the present inventive concept, the first memory 110 may be volatile memory, and the second memory 120 may be non-volatile memory. In an exemplary embodiment of the present inventive concept, the first and second memories 110 and 120 may be volatile memories. In an exemplary embodiment of the present inventive concept, the first and second memories 110 and 120 may be non-volatile memories. For example, the volatile memory may include DRAM, mobile DRAM, synchronous DRAM (SDRAM), double data rate (DDR) DRAM, low power double data rate (LPDDR) SDRAM, graphics double data rate (GDDR) SDRAM, Rambus DRAM (RDRAM), or the like. For example, the non-volatile memory may include NAND flash memory, NOR flash memory, PRAM, magnetic random access memory (MRAM), resistive random access memory (ReRAM), ferroelectric random access memory (FRAM), or the like.

According to the present embodiment, the first memory 110 may be configured to store a first portion of an object, and the second memory 120 may include first and second storage spaces 121 and 122 for duplicately storing a second portion of the object. The object may include object data. Object data may include a moving picture, an image or a stream type file. For example, the second portion of the object may be copied and stored in each of the first and second storage spaces 121 and 122. Thus, the duplicately storing may be understood as redundantly storing or supplemental storing. The controller 130 may index a storage address of the object based on an identifier (ID) or a key of the object, and may control a write operation and a read operation with respect to the object according to the storage address. For example, the controller 130 may store a first storage address of the stored first portion and second storage addresses of the duplicately-stored second portions in an indexed structure.

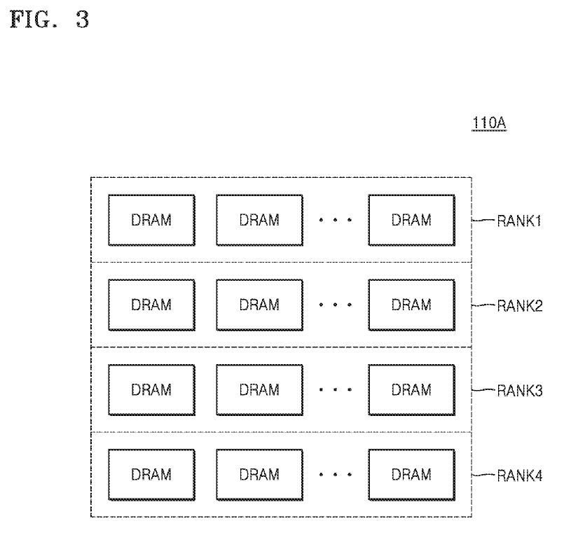

FIG. 3 illustrates an example 110A of the first memory 110 shown in FIG. 2.

Referring to FIG. 3, the first memory 110A may include a plurality of memories that are homogeneous memories. In the present embodiment, the first memory 110A may include a plurality of DRAMs, and for example, the plurality of DRAMs may configure first through fourth ranks RANK1 through RANK4. Each of the plurality of DRAMs may be independently accessed by a controller (e.g., the controller 130 of FIG. 2), and some DRAMs belonging to different ranks may be simultaneously accessed in a parallel manner by the controller.

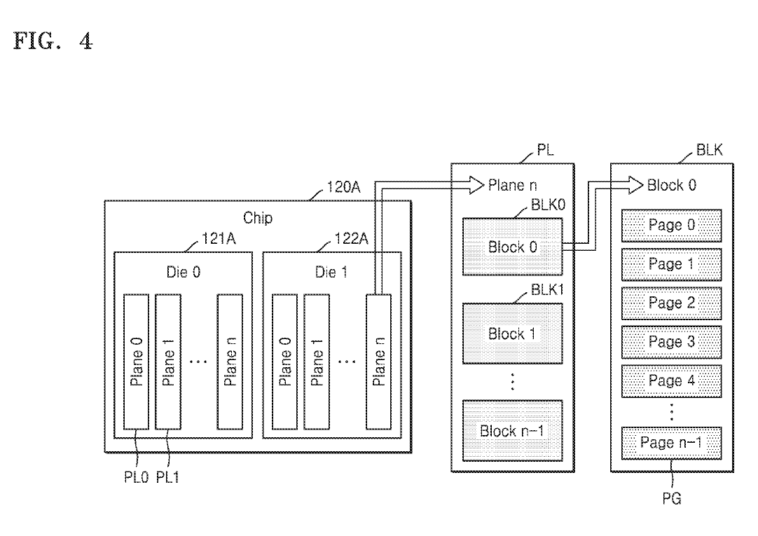

FIG. 4 illustrates an example 120A of the second memory 120 shown in FIG. 2. Referring to FIG. 4, the second memory 120A may be a NAND flash memory and may be embodied as a single chip. The second memory 120A may include first and second storage spaces 121A and 122A, and the first and second storage spaces 121A and 122A may correspond to first and second dies, respectively. According to the present embodiment, a second portion of an object may be copied and may be stored in each of at least one page included in the first storage space 121A and at least one page included in the second storage space 122A.

In an exemplary embodiment of the present inventive concept, the first and second storage spaces 121 and 122 of FIG. 2 may be positioned in different planes, respectively. For example, the first storage space 121 of FIG. 2 may correspond to an area of a first plane PL0, and the second storage space 122 of FIG. 2 may correspond to an area of a second plane PL1. In this regard, the second portion of the object may be copied and stored in each of at least one page included in the first plane PL0 and at least one page included in the second plane PL1.

In an exemplary embodiment of the present inventive concept, the first and second storage spaces 121 and 122 of FIG. 2 may be respectively positioned in different blocks in one plane. For example, the first storage space 121 of FIG. 2 may correspond to an area of a first block BLK0, and the second storage space 122 of FIG. 2 may correspond to an area of a second block BLK1. In this regard, the second portion of the object may be copied and stored in each of at least one page included in the first block BLK0 and at least one page included in the second block BLK1. In FIG. 4, PL may refer to a plane and PG may refer to a page, for example.

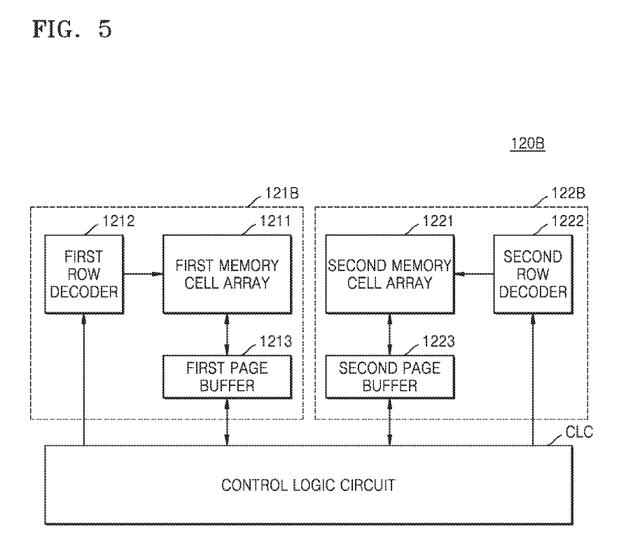

FIG. 5 is a block diagram of an example 120B of the second memory 120 shown in FIG. 2. Referring to FIG. 5, the second memory 120B may include first and second storage spaces 121B and 122B and a control logic circuit CLC. The first storage space 121B may include a first memory cell array 1211, a first row decoder 1212, and a first page buffer 1213. The second storage space 122B may include a second memory cell array 1221, a second row decoder 1222, and a second page buffer 1223.

The first memory cell array 1211 included in the first storage space 121B and the second memory cell array 1221 included in the second storage space 122B may be controlled independently from each other or may be simultaneously controlled. Therefore, a controller (e.g., the controller 130 of FIG. 2) may control operations in parallel with respect to the first and second storage spaces 121B and 122B. In this regard, a second portion of an object may be copied and stored in each of at least one page included in the first memory cell array 1211 and at least one page included in the second memory cell array 1221. Here, the first and second memory cell arrays 1211 and 1221 may be called memory planes.

Referring back to FIG. 2, in the present embodiment, the object storage device 100 may be a key-value store. The key-value store is a device to rapidly and simply process data by using a key-value pair. In this regard, the key-value pair identifies a pair of a key having uniqueness and a value of data corresponding to the key. In the key-value pair, the key may be expressed as a file name, a uniform resource identifier (URL), or a string such as a hash, and the value may be the data such as an image, a user-preferred file or document, or the like. In this regard, according to a type of the data, a size of the value may be changed.

Hereinafter, an exemplary embodiment of the present inventive concept in which the object storage device 100 is the key-value store will now be described. Herein, the object storage device 100 may be substantially the same as the key-value store. However, the object storage device 100 is not limited to the key-value store, and may be applied to any object cache system or any object storage system which manages data by units of objects. Therefore, the object storage device 100 may manage data by units of objects in a way different from the key-value pair.

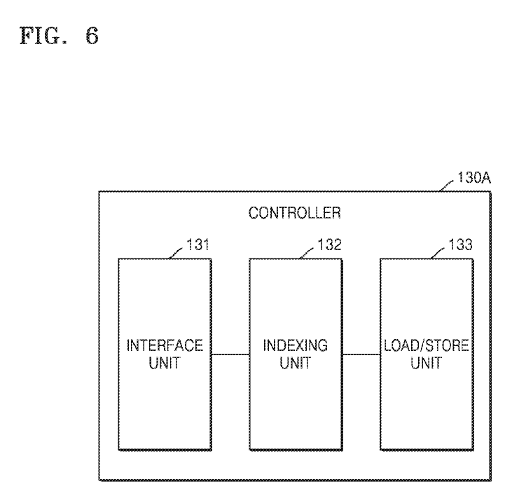

FIG. 6 is a block diagram of an example 130A of the controller 130 shown in FIG. 2. Referring to FIG. 6, the controller 130A may include an interface unit 131, an indexing unit 132, and a load/store unit 133. Each of the interface unit 131, the indexing unit 132, and the load/store unit 133 may be an intellectual property (IP).

The interface unit 131 may communicate with an external source according to a first data format, and may communicate with an internal source, e.g., the indexing unit 132, according to a second data format. For example, the first data format may be an Ethernet scheme for allowing the interface unit 131 to communicate with the application server AS via the second network NET2 of FIG. 1. For example, the second data format may be a peripheral component Internet express (PCIe) format or a vendor format defined by a manufacturer of an object cache server device.

The interface unit 131 may receive an access request (e.g., a write request or a read request) from an external device. In the present embodiment, when the access request is the write request, the interface unit 131 may receive a packet including a setting command (e.g., SET) corresponding to the write request, a key, and a value. When the access request is the read request, the interface unit 131 may receive a packet including an obtainment command (e.g., GET) corresponding to the read request, and a key.

The indexing unit 132 may index a storage address of an object, based on an ID or a key of the object. The indexing unit 132 may previously determine a threshold value for comparison with a size of the object, based on a transmission bandwidth and a read time of the second memory 120 whose response speed is relatively slow. In other words, slower than that of the first memory 110. For example, the indexing unit 132 may determine the threshold value as a value obtained by multiplying the transmission bandwidth by the read time of the second memory 120. The threshold value may be predetermined or adaptively adjusted.

In the present embodiment, the indexing unit 132 may compare the size of the object with the threshold value. When the size of the object is greater than the threshold value, the indexing unit 132 may divide the object into a plurality of portions and may store, in an indexed structure, storage addresses of the portions to be stored. In addition, when the size of the object is greater than the threshold value, the indexing unit 132 may search for each of the storage addresses of the stored portions in the indexed structure.

A condition for the indexing unit 132 to divide the object is not limited to the size of the object. For example, the indexing unit 132 may divide the object according to various conditions. For example, the indexing unit 132 may divide the object, based on information of the first and second memories 110 and 120, a number of writing/reading operations of the object, an access request received via the interface unit 131, a power operation mode of the controller 130A, or a priority of a dividing operation.

In addition, the indexing unit 132 may determine whether to divide the object, and the number of the plurality of divided portions, according to a threshold value of each of the conditions. When the object is not divided, the indexing unit 132 may determine which one of the first memory 110 and the second memory 120 is to store the object. When the object is divided, the indexing unit 132 may determine that object is to be stored only in a plurality of storage addresses of the first memory 110, a plurality of storage addresses of the second memory 120, or the plurality of storage addresses of the first and second memories 110 and 120. In addition, the indexing unit 132 may determine the storage addresses of the second memory 120 in die units, plane units, or chip units.

In an exemplary embodiment of the present inventive concept, the indexing unit 132 may divide the object, based on the information of the first and second memories 110 and 120. In this case, the information of the first and second memories 110 and 120 may be a state of the first memory 110, a remaining storage capacity of the second memory 120, or the like. For example, when the remaining storage capacity of the second memory 120 is equal to or greater than a threshold storage capacity, the indexing unit 132 may divide the object. In an exemplary embodiment of the present inventive concept, the indexing unit 132 may divide the object into the plurality of portions, based on the number of writing/reading operations of the object, according to a read/write history of the object. For example, when the object is frequently read or written, the indexing unit 132 may determine not to divide the object but to store the object in the first memory 110. In an exemplary embodiment of the present inventive concept, the indexing unit 132 may divide the object into the plurality of portions, based on the access request received via the interface unit 131. For example, the indexing unit 132 may receive, from a host, a request or command to instruct the division of the object.

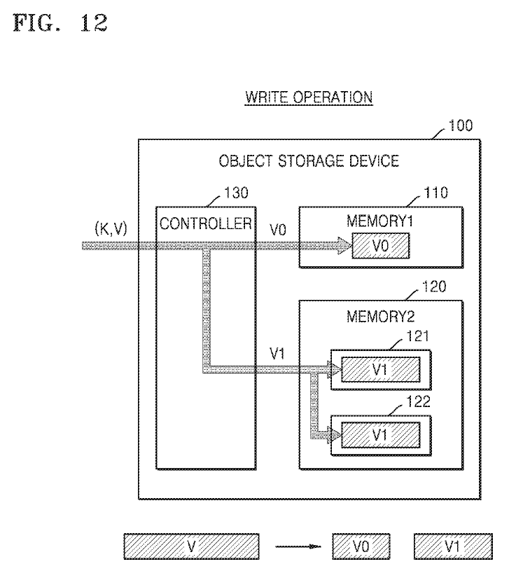

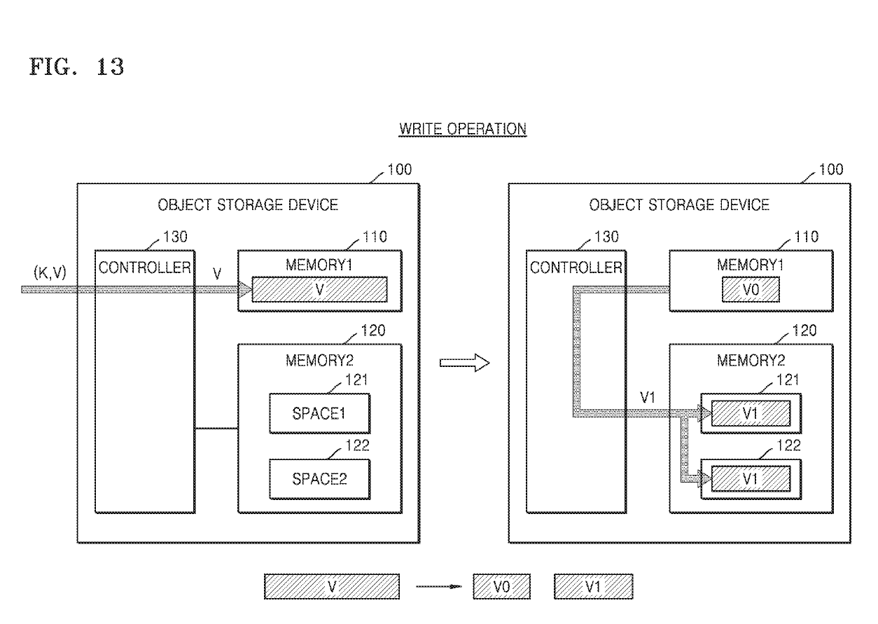

In an exemplary embodiment of the present inventive concept, the indexing unit 132 may pre-process the division of the object. For example, as illustrated in FIG. 12, the indexing unit 132 may divide the object and may determine the storage addresses of the first and second memories 110 and 120. In an exemplary embodiment of the present inventive concept, the indexing unit 132 may pre-process storage of the object, and then may process the division of the object. For example, as illustrated in FIG. 13, the indexing unit 132 may not divide the object but may determine a storage address of the first memory 110 to first store the object, and then may divide the object to allow the second memory 120 to store a portion of the object stored in the first memory 110 and may determine storage addresses of the second memory 120.

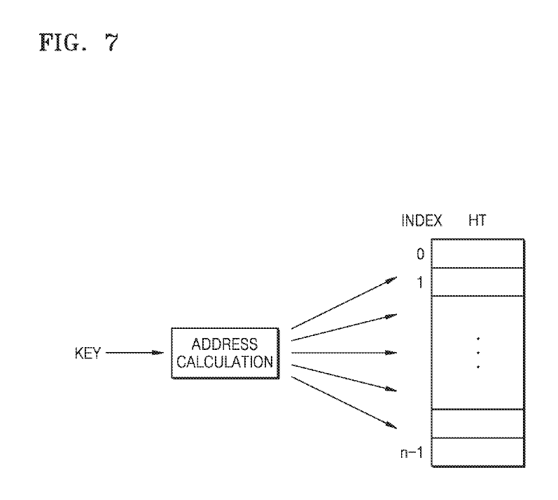

FIG. 7 illustrates an example of an operation by the indexing unit 132 shown in FIG. 6. Referring to FIGS. 6 and 7, the indexing unit 132 may receive a key and a value from the interface unit 131, may generate an index by performing a hash calculation based on the key, and may store a storage address of an object in a hash table HT, based on the generated index. In addition, the indexing unit 132 may receive a key from the interface unit 131, may generate an index by performing a hash calculation based on the key, and may search for the storage address of the object in the hash table HT, based on the generated index. The hash table HT may be stored in an area of the first memory 110.

Referring back to FIGS. 2 and 6, in the present embodiment, when a write request is received, the indexing unit 132 may compare the size of the received value with the threshold value. As a result of the comparison, when the size of the value is greater than the threshold value, the indexing unit 132 may divide the value into a plurality of partial values, and may store, in an indexed structure, storage addresses of partial values to be stored. For example, the storage addresses may respectively correspond to areas of the first memory 110 whose response speed is relatively fast and areas of the second memory 120 whose response speed is relatively slow. When the size of the value is equal to or less than the threshold value, the indexing unit 132 may not divide the value and may store, in an indexed structure, a single storage address of the value to be stored. For example, the single storage address may correspond to an area of the first memory 110 whose response speed is relatively fast.

In the present embodiment, when a read request is received, the indexing unit 132 may search for a storage address of a stored value in an indexed structure by using a received key. When a size of the value according to the received key is greater than the threshold value, the indexing unit 132 may search for storage addresses of stored partial values corresponding to the value. For example, found storage addresses may respectively correspond to areas of the first memory 110 whose response speed is relatively fast and areas of the second memory 120 whose response speed is relatively slow. When the size of the value according to the received key is equal to or less than the threshold value, the indexing unit 132 may search for a single storage address of the stored value. For example, the found single storage address may correspond to an area of the first memory 110 whose response speed is relatively fast.

Hereinafter, the operation of the indexing unit 132, the operation corresponding to a case where the size of the value is greater than the threshold value, will be described in detail. When the write request is received, the indexing unit 132 may divide the value into a first value and a second value, may store a storage address of the stored first value as an area of the first memory 110, and may store storage addresses of the duplicately-stored second value as areas of the second memory 120. When the read request is received, the indexing unit 132 may search for a storage address of the first memory 110 with respect to the stored first value, and storage addresses of the second memory 120 with respect to the duplicately-stored second value. In addition, the indexing unit 132 may select one of found storage addresses of the second memory 120, based on an operational state of the second memory 120. For example, the indexing unit 132 may select a storage address to allow the second value to be read from one of the first and second storage spaces 121 and 122 of the second memory 120.

Based on storage addresses corresponding to a result indexed by the indexing unit 132, the load/store unit 133 may control a loading operation for retrieving data from the first memory 110 or the second memory 120, and a store operation for storing data in a storage address of the first memory 110 or the second memory 120. In the present embodiment, when an indexed result corresponds to a single storage address, the load/store unit 133 may control a loading operation for retrieving data from the first memory 110 and a store operation for storing data in a storage address of the first memory 110.

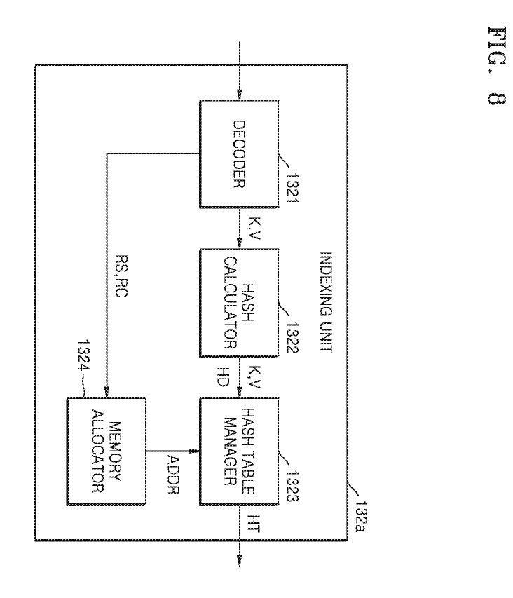

FIG. 8 is a block diagram of an example 132a of the indexing unit 132 shown in FIG. 6. Referring to FIG. 8, the indexing unit 132a may include a decoder 1321, a hash calculator 1322, a hash table manager 1323, and a memory allocator 1324.

When a write request is received, the decoder 1321 may extract a key K and a value V by decoding data received from the interface unit 131, and may output the extracted key K and value V to the hash calculator 1322. In addition, the decoder 1321 may generate a request size RS and a request count RC from the value V, and may output the request size RS and the request count RC to the memory allocator 1324. In a case of a read request, the decoder 1321 may extract the key K by decoding the data received from the interface unit 131, and may output the extracted key K to the hash calculator 1322.

The hash calculator 1322 may receive the key K or the key K and value V from the decoder 1321. The hash calculator 1322 may generate hash data HD by performing a hash operation on the received key K. For example, the hash calculator 1322 may perform a full hash operation or a partial hash operation on the received key K. The hash calculator 1322 may output the hash data HD and the key K, or the hash data HD, the key K, and the value V to the hash table manager 1323.

The memory allocator 1324 may receive the request size RS and the request count RC from the decoder 1321. The memory allocator 1324 may allocate storage spaces requested by the request size RS and the request count RC, and may output addresses ADDR of the allocated storage spaces to the hash table manager 1323. For example, the request size RS and the request count RC may identify storage spaces requested for the write operation.

When the write request is received, the hash table manager 1323 may receive the key K, the value V, and the hash data HD from the hash calculator 1322, and may receive the addresses ADDR from the memory allocator 1324. The hash table manager 1323 may control the load/store unit 133 to update a hash table HT stored in a memory indicated by the hash data HD. The memory may be one of the first and second memories 110 and 120.

When the read request is received, the hash table manager 1323 may receive the key K and the hash data HD from the hash calculator 1322. The hash table manager 1323 may control the load/store unit 133 to read the hash table HT of the memory indicated by the hash data HD. The memory may be one of the first and second memories 110 and 120. Based on the hash table HT, the hash table manager 1323 may extract the addresses ADDR corresponding to the key K.

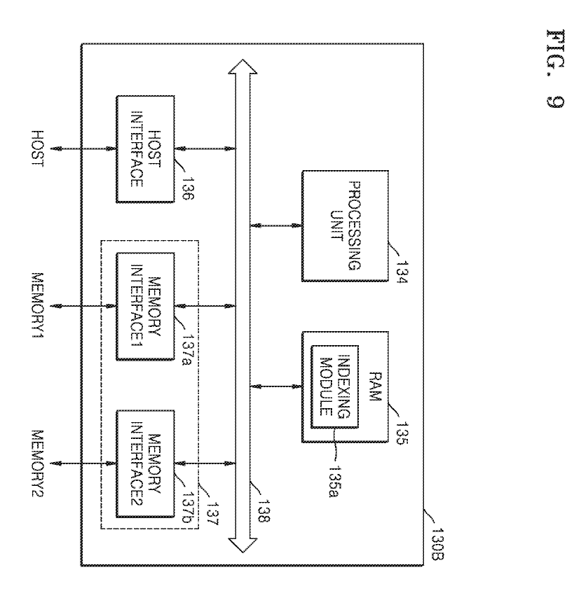

FIG. 9 is a block diagram of an example 130B of the controller 130 shown in FIG. 2. Referring to FIG. 9, the controller 130B may include a processing unit 134, a RAM 135, a host interface 136, and memory interfaces 137. The processing unit 134, the RAM 135, the host interface 136, and the memory interfaces 137 may communicate with each other via a bus 138.

The processing unit 134 may include a central processing unit, a microprocessor, or the like, and may control operations performed by the controller 130B. According to the present embodiment, an indexing module 135a or data used in performing an indexing operation may be loaded to the RAM 135.

The host interface 136 may provide an interface between a host (e.g., one of the application server devices AS of FIG. 1) and the controller 130B. For example, the host interface 136 may correspond to the interface unit 131 of FIG. 6. A first memory interface 137a may provide an interface between the controller 130B and the first memory 110. A second memory interface 137b may provide an interface between the controller 130B and the second memory 120. For example, the first and second memory interfaces 137a and 137b may correspond to the load/store unit 133 of FIG. 6.

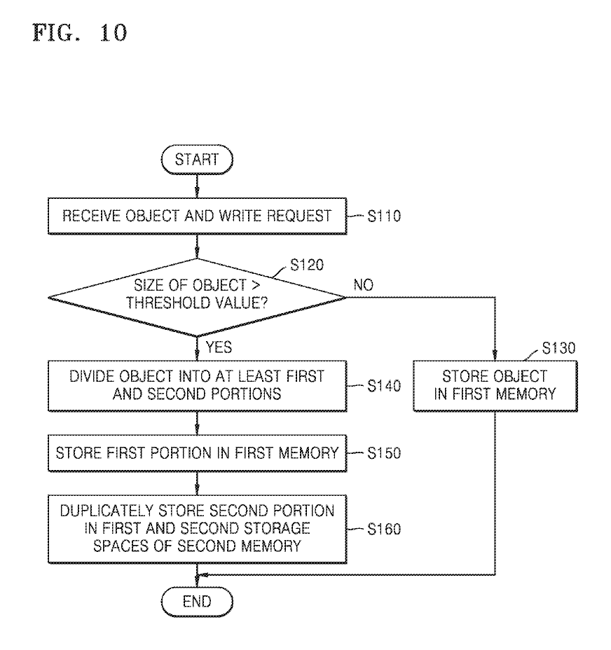

FIG. 10 is a flowchart of an operating method of an object storage device, according to an exemplary embodiment of the present inventive concept. Referring to FIG. 10, the operating method of the object storage device according to the present embodiment illustrates an operation of writing data by units of objects to the object storage device and may include, for example, processes that are chronologically performed in the object storage device 100 of FIG. 2. Descriptions made above with reference to FIGS. 1 through 9 may also be applied to the present embodiment, and thus, repeated descriptions are not included.

In operation S110, an object and a write request are received. For example, the interface unit 131 included in the controller 130 may receive the object and the write request from a host. For example, the object may include a key-value pair, and the write request may include a setting command (e.g., SET).

In operation S120, it is determined whether a size of the object is greater than a threshold value. For example, the indexing unit 132 may compare the size of the object with the threshold value. For example, when the object includes the key-value pair, the indexing unit 132 may determine whether a size of the value is greater than the threshold value. As a result of the determination, when the size of the object is greater than the threshold value, operation S140 is performed, and when the size of the object is equal to or less than the threshold value, operation S130 is performed.

In an exemplary embodiment of the present inventive concept, the operating method performed by the object storage device may further include determining the threshold value before the operation S110 or S120. In the present embodiment, the threshold value may be determined based on the second latency of the second memory 120 whose response speed is relatively slow. For example, the threshold value may be determined based on a value obtained by multiplying a read time of the second memory 120 by a transmission bandwidth of the object storage device 100. In this regard, the smaller the threshold value determined, the more the data may be stored in the second memory 120, and thus, a storage capacity of the object storage device 100 may be further increased.

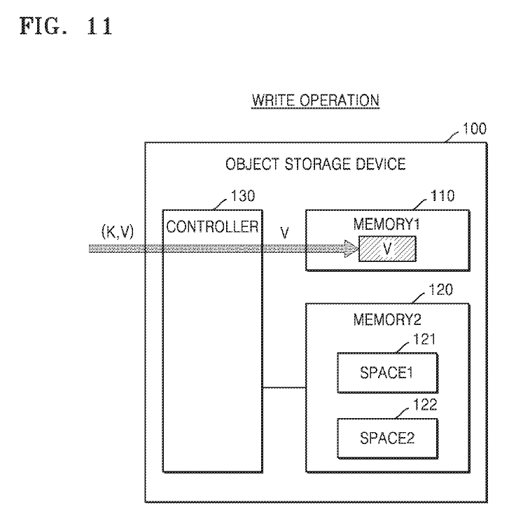

In operation S130, the object is stored in the first memory 110. For example, the indexing unit 132 may index a storage address of the object to a storage space of the first memory 110, and the load/store unit 133 may control the first memory 110 to write the object to the first memory 110. The operation S130 will now be described in detail with reference to FIG. 11.

FIG. 11 illustrates a write operation with respect to the object storage device 100 of FIG. 2, according to an exemplary embodiment of the present inventive concept.

Referring to FIG. 11, the controller 130 may receive a pair of a key K and value V, and may determine a size of the value V according to the received pair of the key K and value V. When the size of the value V is equal to or less than a threshold value, the controller 130 may control the first memory 110 to write the value V to the first memory 110. In this case, when the size of the value V is equal to or less than the threshold value, the object storage device 100 may store an object in the first memory 110 whose write speed is relatively fast, and may not access the second memory 120 whose write speed is relatively slow. Therefore, a write operation speed of the object storage device 100 may remain fast.

According to the present embodiment, when a read request with respect to the value V is received, the object storage device 100 may not access the second memory 120 whose response speed is relatively slow but may access the first memory 110 whose write speed is relatively fast and then may read the value V. Therefore, a read operation speed of the object storage device 100 may also remain fast.

Referring back to FIG. 10, in operation S140, the object is divided into at least first and second portions. For example, the indexing unit 132 may divide the object into at least first and second portions, may index a first storage address for storing the first portion to a storage space of the first memory 110, and may index second storage addresses for duplicately storing the second portion to storage spaces of the second memory 120. In this case, the indexing unit 132 may store the first storage address and the second storage addresses in an indexed structure. Here, the indexing unit 132 may divide the object into three or more portions.

In operation S150, the first portion is stored in the first memory 110. For example, the load/store unit 133 may control the first memory 110 to store the first portion in a storage space of the first memory 110, the storage space corresponding to a first storage address. In operation S160, the second portion is duplicately stored in first and second storage spaces of a second memory. For example, the load/store unit 133 may control the second memory 120 to duplicately store the second portion in the first and second storage spaces 121 and 122. In other words, the second portion is stored in both of the first and second storage spaces 121 and 122.

In the present embodiment, the operation S160 may include determining whether all of the first and second storage spaces 121 and 122 are in an idle state, and duplicately storing the second portion in a sequential manner in the first and second storage spaces 121 and 122 when all of the first and second storage spaces 121 and 122 are in the idle state. Here, the idle state indicates a state in which a write operation, a read operation, or an erase operation with respect to the first and second storage spaces 121 and 122 is not currently performed. The operations S140 through S160 will now be described in detail with reference to FIGS. 12 and 13.

FIG. 12 illustrates a write operation with respect to the object storage device 100 of FIG. 2, according to an exemplary embodiment of the present inventive concept.

Referring to FIG. 12, the controller 130 may receive a pair of a key K and value V, and may determine a size of the value V according to the received pair of the key K and value V. When the size of the value V is greater than a threshold value, the controller 130 may divide the value V into first and second partial values V0 and V1. In the present embodiment, the first partial value V0 may correspond to a head portion of the value V, and the second partial value V1 may correspond to a tail portion of the value V. However, the inventive concept is not limited thereto, and the controller 130 may variously change the number of partial values divided from the value V. In other words, the value V may be divided into more than two portions.

Afterward, the controller 130 may control the first memory 110 to write the first partial value V0 to the first memory 110, and may control the second memory 120 to write the second partial value V1 to each of the first and second storage spaces 121 and 122 of the second memory 120. According to the present embodiment, when a size of an object is greater than the threshold value, the first partial value V0 may be stored in the first memory 110 whose response speed is relatively fast and the second partial value V1 may be stored in the second memory 120 whose response speed is relatively slow. By doing so, a storage capacity of the object storage device 100 may be increased by a storage capacity of the second memory 120. In this case, according to the present embodiment, the controller 130 may first divide the value V, and then, may control the storage of the divided first and second partial values V0 and V1.

In addition, the controller 130 may determine whether all of the first and second storage spaces 121 and 122 are in an idle state, and when all of the first and second storage spaces 121 and 122 are in the idle state, the controller 130 may control the second memory 120 to duplicately store the second partial value V1 in a sequential manner in the first and second storage spaces 121 and 122. For example, when all of the first and second storage spaces 121 and 122 are in the idle state, the second partial value V1 may be first stored in the first storage space 121, and then, may be stored in the second storage space 122. Since a write operation is sequentially performed on the first and second storage spaces 121 and 122, if a read operation with respect to a second portion is performed at a later time, an immediate read operation with respect to one of the first and second storage spaces 121 and 122 may be guaranteed. Therefore, when the read operation with respect to the second portion is performed, an additional latency may not occur.

If the second partial value V1 is not duplicately stored in the second memory 120, while a write, read, or erase operation with respect to a block storing the second partial value V1 is being performed, a read operation with respect to the second partial value V1 cannot be performed. Accordingly, an additional latency for the read operation with respect to the second partial value V1 may occur, such that a read function of the object memory device may deteriorate. However, according to the present embodiment, since the second partial value V1 is duplicately stored in the first and second storage spaces 121 and 122 of the second memory 120, the additional latency for the read operation with respect to the second partial value V1 may not occur.

FIG. 13 illustrates the write operation with respect to the object storage device 100 of FIG. 2, according to an exemplary embodiment of the present inventive concept.

Referring to FIG. 13, a write operation according to the present embodiment may correspond to a modified example of the write operation shown in FIG. 12. Hereinafter, a difference between the examples of FIGS. 12 and 13 is mainly described, and repeated descriptions are not included. The controller 130 may receive a pair of a key K and value V, and may control the first memory 110 to write the value V to the first memory 110. Afterward, the controller 130 may transmit, to a host, a response message indicating the write operation with respect to an object is finished. In this case, according to the present embodiment, regardless of a size of the object, the object may be first stored in the first memory 110 whose operation speed is fast, and then, the response message may be transmitted to the host.

Then, the controller 130 may determine a size of the value V, and when the size of the value V is greater than a threshold value, the controller 130 may divide the value V into a first partial value V0 and a second partial value V1. Afterward, the controller 130 may control the first and second memories 110 and 120 to flush the second partial value V1 of the value V stored in the first memory 110 to the first and second storage spaces 121 and 122. In other words, remove the second partial value V1 from the first memory 110 and store it in the first and second storage spaces 121 and 122 of the second memory 120. In the present embodiment, the controller 130 may determine whether all of the first and second storage spaces 121 and 122 are in an idle state, and as a result of the determination, when all of the first and second storage spaces 121 and 122 are in the idle state, the controller 130 may control the second memory 120 to duplicately store the second partial value V1 sequentially in the first storage space 121 and the second storage space 122. In this case, according to the present embodiment, the controller 130 may first store the value V, and then, may control the division of the value V and the storage of the divided first and second partial values V0 and V1.

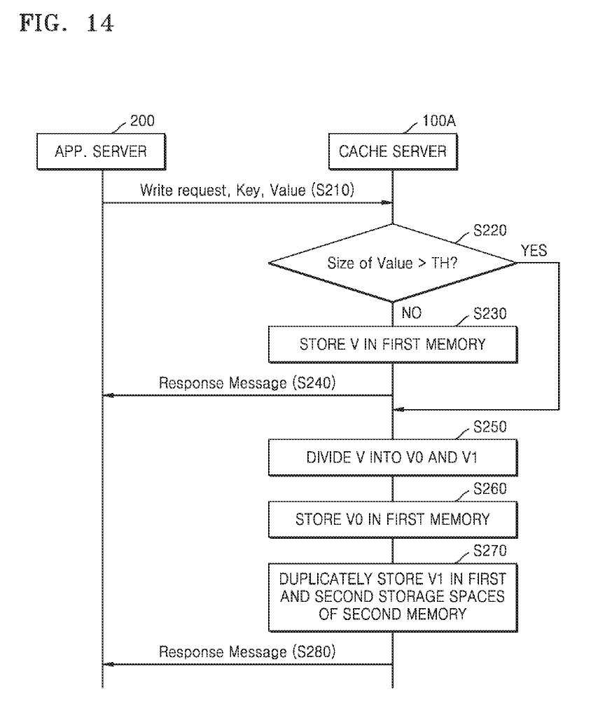

FIG. 14 is a flowchart illustrating operations between an application server 200 and a cache server 100A, according to an exemplary embodiment of the present inventive concept.

Referring to FIG. 14, the cache server 100A is an example of the object storage device 100 of FIG. 2, and may correspond to one of the object cache server devices OCS of FIG. 1. The application server 200 may correspond to one of the application server devices AS of FIG. 1.

In operation S210, the application server 200 transmits a write request, a key, and a value to the cache server 100A. The application server 200 may transmit the write request, the key, and the value to the cache server 100A via a second network (e.g., the second network NET2 of FIG. 1). Here, the write request may include a setting command. A size of the value may be changed according to the key.

In operation S220, the cache server 100A determines whether the size of the value is greater than a threshold value TH. As a result of the determination, when the size of the value is greater than the threshold value TH, the cache server 100A may perform operation S250, and when the size of the value is equal to or less than the threshold value TH, the cache server 100A may perform operation S230. However, the inventive concept is not limited thereto, and in an exemplary embodiment of the present inventive concept, if the size of the value is greater than the threshold value TH, the cache server 100A may perform operations S230 and S240, and then, may perform operation S250. In this case, operation S280 may not be performed.

In operation S230, the cache server 100A stores the value V in a first memory. In operation S240, the cache server 100A transmits, to the application server 200, a response message indicating completion of the write operation. The cache server 100A may transmit the response message to the application server 200 via the second network (e.g., the second network NET2 of FIG. 1). However, the inventive concept is not limited thereto, and in an exemplary embodiment of the present inventive concept, operations S230 and S240 may be performed before operation S220 is performed.

In operation S250, the cache server 100A divides the value V into a first partial value V0 and a second partial value V1. In operation S260, the cache server 100A stores the first partial value V0 in the first memory (e.g., a relatively fast memory). In operation S270, the cache server 100A duplicately stores the second partial value V1 in first and second storage spaces of a second memory (e.g., a relatively slow memory). In operation S280, the cache server 100A transmits, to the application server 200, a response message indicating completion of the write operation. The cache server 100A may transmit the response message to the application server 200 via the second network (e.g., the second network NET2 of FIG. 1).

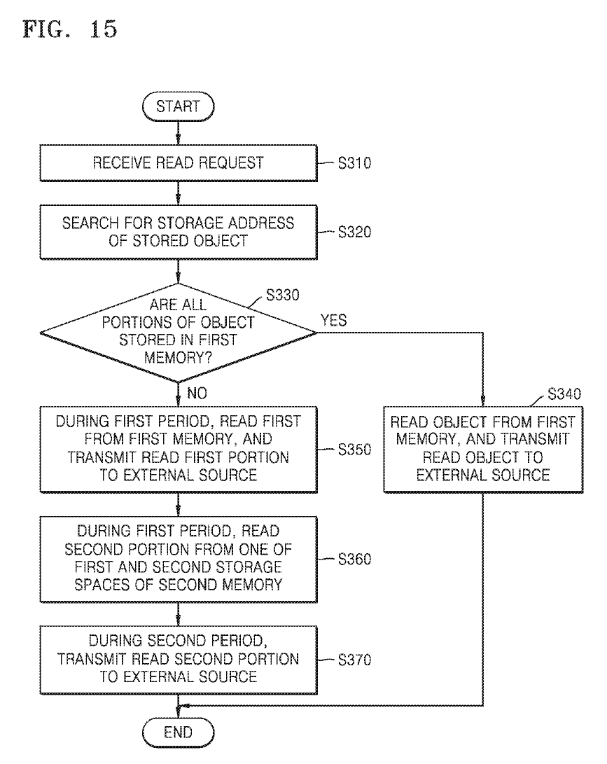

FIG. 15 is a flowchart of an operating method of an object storage device, according to an exemplary embodiment of the present inventive concept. Referring to FIG. 15, the operating method of the object storage device according to the present embodiment indicates an operation of writing data by units of objects to the object storage device and may include, for example, processes that are chronologically performed in the object storage device 100 of FIG. 2. Descriptions made above with reference to FIGS. 1 through 14 may also be applied to the present embodiment, and repeated descriptions are not included.

In operation S310, a read request is received. For example, the interface unit 131 included in the controller 130 may receive the read request from a host. For example, the controller 130 may receive the read request along with a key, and the read request may include an obtainment command (e.g., GET).

In operation S320, a storage address of a stored object is searched for. For example, the indexing unit 132 may search for the storage address of the object stored in an index structure by using the received key. In operation S330, it is determined whether all portions of the object are stored in the first memory 110. In other words, it is determined whether the found storage address is a single storage address. As a result of the determination, if all portions of the object are stored in the first memory 110, operation S340 may be performed, but if not, operation S350 may be performed.

In an exemplary embodiment of the present inventive concept, the operating method of the object storage device may further include determining a threshold value before operation S310 or operation S320 is performed. In addition, in an exemplary embodiment of the inventive concept, the determining of the threshold value may be performed while the object storage device is configured. In the present embodiment, the threshold value may be determined based on a second latency of the second memory 120 whose response speed is relatively slow. For example, the threshold value may be determined based on a value obtained by multiplying a read time of the second memory 120 by a transmission bandwidth of the object storage device 100. In this case, when the threshold value is small, more data may be stored in the second memory 120, therefore a storage capacity of the object storage device 100 may be further increased. Therefore, when the read time of the second memory 120 is decreased, the storage capacity of the object storage device 100 may be increased. In addition, a storage efficiency of the object storage device 100 may be increased by decreasing the read time of the second memory 120 by duplicately storing the data in the second memory 120.

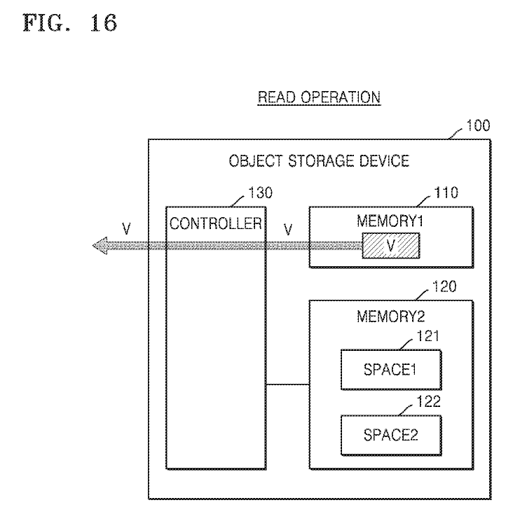

In operation S340, the object is read from the first memory 110 and the read object is transmitted to an external source. For example, the load/store unit 133 may read, by using the found storage address, a value according to the key received from the first memory 110, and may transmit the read value to the host. The operation S340 will now be described in more detail with reference to FIG. 16.

FIG. 16 illustrates a read operation with respect to the object storage device 100 shown in FIG. 2, according to an exemplary embodiment of the present inventive concept.

Referring to FIG. 16, the controller 130 may receive a key and may search for a storage address of a value V by using the received key. As a result of the search, when a storage address of all portions of the value V corresponds to the first memory 110, the controller 130 may control the first memory 110 to read the value V from the first memory 110. Then, the controller 130 may transmit the read value V to the external source. As described above with reference to FIG. 11, when a size of the value V is equal to or less than a threshold value, the value V may not be divided and may be stored in the first memory 110.

In this case, when a size of an object is equal to or less than the threshold value, the controller 130 may read the value V by accessing the first memory 100 whose read speed is relatively fast, and in this case, the controller 130 may not access the second memory 120 whose read speed is relatively slow. Therefore, a read operation speed of the object storage device 100 may remain fast.

Referring back to FIG. 15, in operation S350, during a first period, a first portion is read from the first memory 110, and the read first portion is transmitted to the external source. In operation S360, during the first period, a second portion is read from one of the first and second storage spaces 121 and 122 of the second memory 120. Operations S350 and S360 may be performed at the same time or very close in time. In operation S370, the read second portion is transmitted to the external source. The operation S370 may be performed right after the operations S350 and S360 are performed.

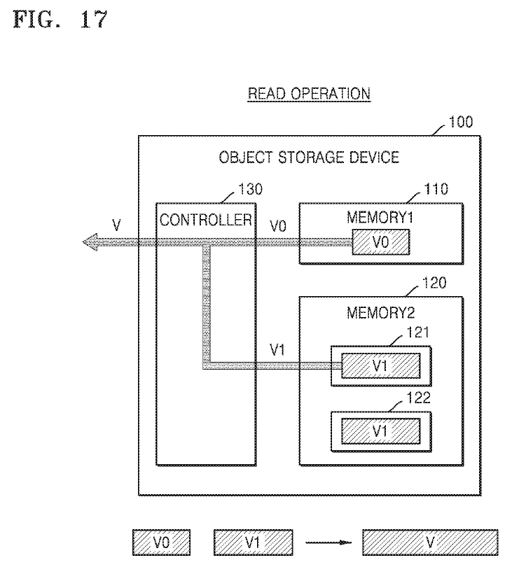

In the present embodiment, the operation S360 may include selecting a storage space in an idle state, the storage space being from among the first and second storage spaces 121 and 122, and reading the second portion from the selected storage space. Here, the idle state indicates a state in which a write operation, a read operation, or an erase operation with respect to the first and second storage spaces 121 and 122 is not currently performed. The operations S350 through S370 will now be described in detail with reference to FIG. 17.

FIG. 17 illustrates a read operation with respect to the object storage device 100 shown in FIG. 2, according to an exemplary embodiment of the present inventive concept.

Referring to FIG. 17, the controller 130 may receive a key, and may search for a storage address of a value V by using the received key. As a result of the search, when storage addresses of first and second partial values V0 and V1 of the value V correspond to the first and second memories 110 and 120, respectively, the controller 130 may control the first and second memories 110 and 120 to simultaneously perform read operations with respect to the first and second memories 110 and 120.

For example, the controller 130 may control the first memory 110 to read the first partial value V0 from the first memory 110, and may control the second memory 120 to read the second partial value V1 from one of the first and second storage spaces 121 and 122 of the second memory 120. The first partial value V0 may correspond to a head portion of the value V, and the second partial value V1 may correspond to a tail portion of the value V.

The controller 130 may select one of the first and second storage spaces 121 and 122, based on states of the first and second storage spaces 121 and 122 of the second memory 120, and may read the second partial value V1 from the selected storage space. For example, the controller 130 may select a storage space in an idle state, the storage space being from among the first and second storage spaces 121 and 122. For example, the first storage space 121 may be in the idle state and the second storage space 122 may be in a busy state, and in this case, a write operation, a read operation, or an erase operation may be currently performed on blocks included in the second storage space 122. The controller 130 may access the selected first storage space 121 and may read the second partial value V1 from the first storage space 121.

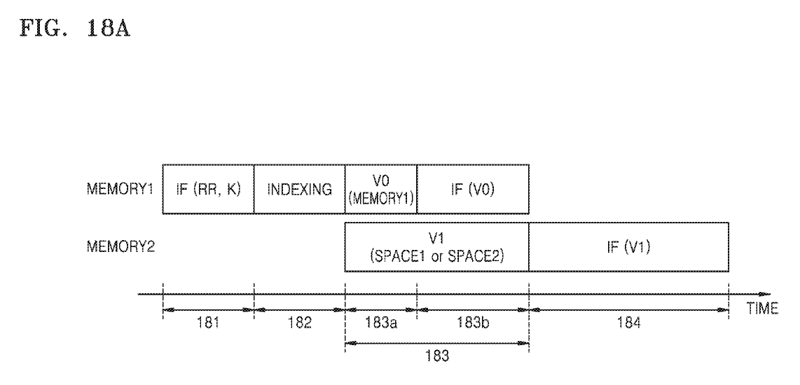

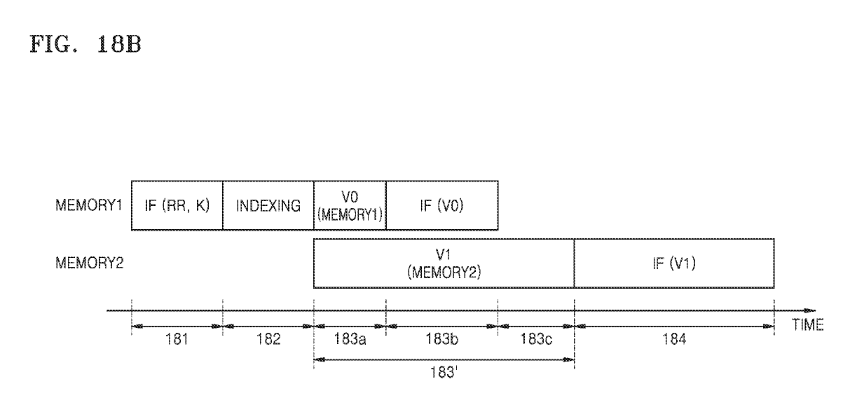

FIG. 18A illustrates a read operation according to time, the read operation being performed by the object storage device 100 shown in FIG. 17, according to an exemplary embodiment of the present inventive concept.

Referring to FIGS. 17 and 18A, during a first period 181, the controller 130 may receive a read request RR and a key K from an external source. The first period 181 may be referred to as an interface period. During a second period 182, the controller 130 may index a storage address of a value according to the key K, based on the key K. The second period 182 may be referred to as an indexing period.

During a third period 183, read operations with respect to the first and second memories 110 and 120 may be simultaneously performed. Here, according to a difference between read speeds of the first and second memories 110 and 120 and sizes of first and second partial values V0 and V1 of the value, the time required for reading the first partial value V0 may be different from the time required for reading the second partial value V1. In the present embodiment, the time required for reading the first partial value V0 may correspond to a read period 183a, and the time required for reading the second partial value V1 may correspond to the third period 183.

The third period 183 may include the read period 183a and a transmission period 183b. During the read period 183a, the first partial value V0 may be read from the first memory 110, and during the transmission period 183b, the read first partial value V0 may be transmitted to an external source. In addition, during the third period 183, the second partial value V1 may be read from the second memory 120. During a fourth period 184, the read second partial value V1 may be transmitted to the external source.

According to the present embodiment, a read time (e.g., the third period 183) of the second partial value V1 may correspond to the total sum of the read period 183a of the first partial value V0 and the transmission period 183b of the first partial value V0. In other words, in view of an interface, although the read period 183 with respect to the second memory 120 is longer than the read period 183a with respect to the first memory 110 by an additional time, the additional time for the second memory 120 may be hidden by the transmission period 183b.

In addition, according to the present embodiment, the first partial value V0 may be transmitted to the external source during the transmission period 183b included in the third period 183, and then, the second partial value V1 may be transmitted to the external source during the fourth period 184. Therefore, in view of the interface between the object storage device 100 and the host, the object storage device 100 may have a read function as if the object storage device 100 reads an entire value from the first memory 110 whose read speed is relatively fast.

In addition, according to the present embodiment, during the third period 183, a storage space in an idle state may be selected from among the first and second storage spaces 121 and 122 of the second memory 120, and the second partial value V1 may be read only from the selected storage space. As described above with reference to FIGS. 12 and 13, according to the present embodiment, the second partial value V1 may be duplicately stored in the first and second storage spaces 121 and 122 in a sequential manner. Accordingly, a period in which a write operation, a read operation, or an erase operation is performed on the first and second storage spaces 121 and 122 at the same time may not occur. Therefore, an idle state of one of the first and second storage spaces 121 and 122 may be ensured, so that an additional delay time may not occur while the second partial value V1 is read from the second memory 120.

FIG. 18B illustrates a read operation according to time, the read operation being performed by an object storage device, according to a comparative example.

Referring to FIG. 18B, according to the comparative example, a first partial value V0 may be stored in a first memory, and a second partial value V1 may be stored in a second memory. In other words, according to the comparative example, the second partial value V1 may not be duplicately stored in first and second storage spaces of the second memory. When a read operation is performed on the second memory during a third period 183′, a write operation, a read operation, or an erase operation may be being performed with respect to a storage address of the second partial value V1 stored in the second memory.

In this case, since the second partial value V1 may be read from the second memory after the write, read, or erase operation that is currently performed is finished, the third period 183′ may be increased by an additional delay time 183c, compared to the third period 183 of FIG. 18A. Therefore, in view of an interface between the object storage device and the host, a read speed of the object storage device may be slower than that of the object storage device 100 of FIG. 18A.

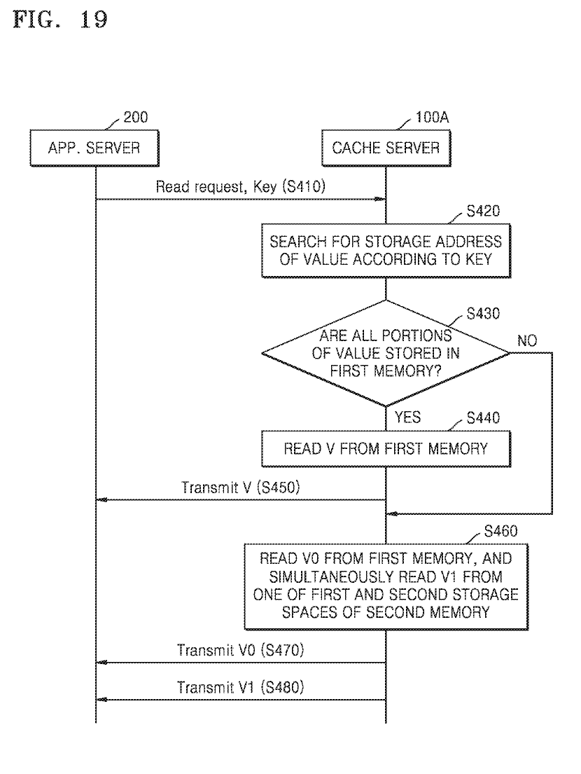

FIG. 19 is a flowchart illustrating operations between the application server 200 and the cache server 100A, according to an exemplary embodiment of the present inventive concept.

Referring to FIG. 19, the cache server 100A is an example of the object storage device 100 of FIG. 2, and may correspond to one of the object cache server devices OCS of FIG. 1. The application server 200 may correspond to one of the application server devices AS of FIG. 1.

In operation S410, the application server 200 transmits a read request and a key to the cache server 100A. The application server 200 may transmit the read request and the key to the cache server 100A via a second network (e.g., the second network NET2 of FIG. 1). Here, the read request may include an obtainment command (e.g., GET). The key is a unique value that specifies a value.

In operation S420, the cache server 100A searches for a storage address of the value according to the key. In operation S430, the cache server 100A determines whether all portions of the value are stored in a first memory. As a result of the determination, if all portions of the value are stored in the first memory, operation S440 may be performed, and if not, operation S460 may be performed.

In operation S440, the cache server 100A reads a value V from the first memory. In operation S450, the cache server 100A transmits the read value V to the application server 200. The cache server 100A may transmit the value V to the application server 200 via the second network (e.g., the second network NET2 of FIG. 1). When operations S440 and S450 are performed, the operations between the application server 200 and the cache server 100A are ended, and operations S460 through S480 are not performed.

In operation S460, the cache server 100A reads a first partial value V0 from the first memory, and simultaneously reads a second partial value V1 from one of first and second storage spaces of the second memory. In operation S470, the cache server 100A transmits the first partial value V0 to the application server 200. In operation S480, the cache server 100A transmits the second partial value V1 to the application server 200. The cache server 100A may transmit the first and second partial values V0 and V1 to the application server 200 via the second network (e.g., the second network NET2 of FIG. 1).

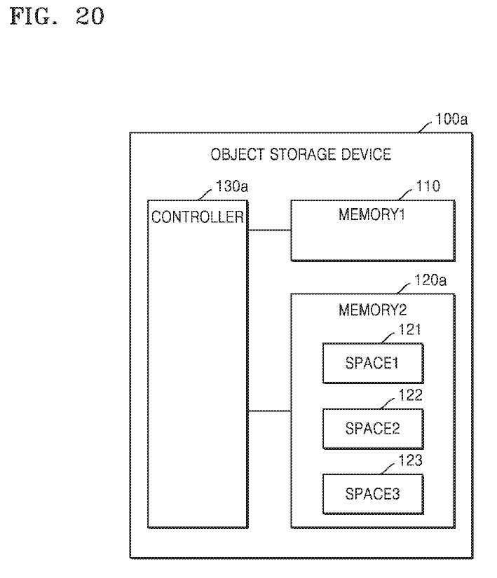

FIG. 20 is a block diagram of an object storage device 100a, according to an exemplary embodiment of the present inventive concept.

Referring to FIG. 20, the object storage device 100a is a modified example of the object storage device 100 of FIG. 2, and may include the first memory 110, a second memory 120a, and a controller 130a. The second memory 120a may include first, second, and third storage spaces 121, 122, and 123. The first and second storage spaces 121 and 122 may be configured to duplicately store a second portion of an object, and the third storage space 123 may be configured to store a third portion of the object. However, the inventive concept is not limited thereto, and the second memory 120a may further include a fourth storage space, and the third storage space 123 and the fourth storage space may be configured to duplicately store the third portion of the object.

In the present embodiment, the first, second, and third storage spaces 121, 122, and 123 may be respectively positioned in first, second, and third dies of the second memory 120a, the first, second, and third dies being different from each other. In an exemplary embodiment of the present inventive concept, the first, second, and third storage spaces 121, 122, and 123 may be respectively positioned in first, second, and third planes of the second memory 120a, the first, second, and third planes being different from each other. In an exemplary embodiment of the present inventive concept, the first, second, and third storage spaces 121, 122, and 123 may be respectively positioned in first, second, and third blocks of the second memory 120a, the first, second, and third blocks being different from each other.

In an exemplary embodiment of the present inventive concept, the first and second storage spaces 121 and 122 may be positioned in a first die of the second memory 120a, and the third storage space 123 may be positioned in a second die of the second memory 120a. In an exemplary embodiment of the present inventive concept, the first and second storage spaces 121 and 122 may be positioned in a first plane of the second memory 120a, and the third storage space 123 may be positioned in a second plane of the second memory 120a. In an exemplary embodiment of the present inventive concept, the first and second storage spaces 121 and 122 may be positioned in a first block of the second memory 120a, and the third storage space 123 may be positioned in a second block of the second memory 120a.

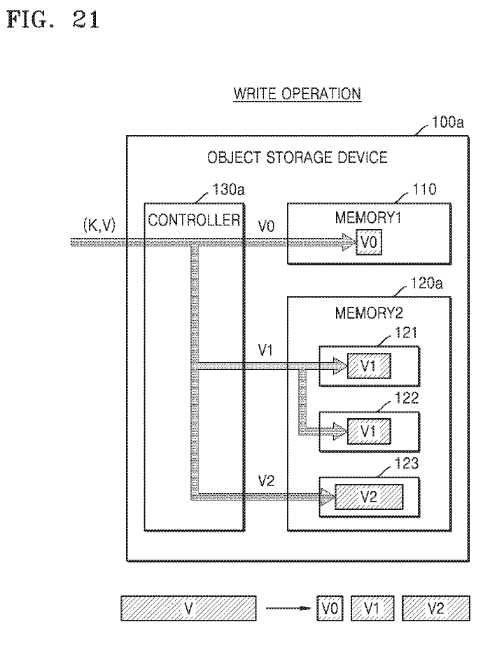

FIG. 21 illustrates an example of a write operation with respect to the object storage device 100a of FIG. 20, according to an exemplary embodiment of the present inventive concept.

Referring to FIG. 21, when a size of a value V is greater than a threshold value, the controller 130a may divide the value V into first, second, and third partial values V0, V1, and V2. In the present embodiment, the first partial value V0 may correspond to a head portion of the value V, the second partial value V1 may correspond to a middle portion of the value V, and the third partial value V2 may correspond to a tail portion of the value V. However, the inventive concept is not limited thereto, and the controller 130a may variously change the number of partial values divided from the value V. For example, the divided number of partial values may be greater than three and the partial values may correspond to other portions of the value V.

Then, the controller 130a may store the first partial value V0 in the first memory 110 whose response speed is relatively fast, and may store the second partial value V1 and the third partial value V2 in the second memory 120a whose response speed is relatively slow. Accordingly, a storage capacity of the object storage device 100a may be increased by a storage capacity of the second memory 120a.

In addition, the controller 130a may determine whether all of the first and second storage spaces 121 and 122 are in an idle state, and as a result of the determination, when all of the first and second storage spaces 121 and 122 are in the idle state, the controller 130a may control the second memory 120a to duplicately store the second partial value V1 sequentially in the first and second storage spaces 121 and 122. When the size of the value V is equal to or less than the threshold value, the controller 130a may not divide the value V and may store all portions of the value V in the first memory 110.

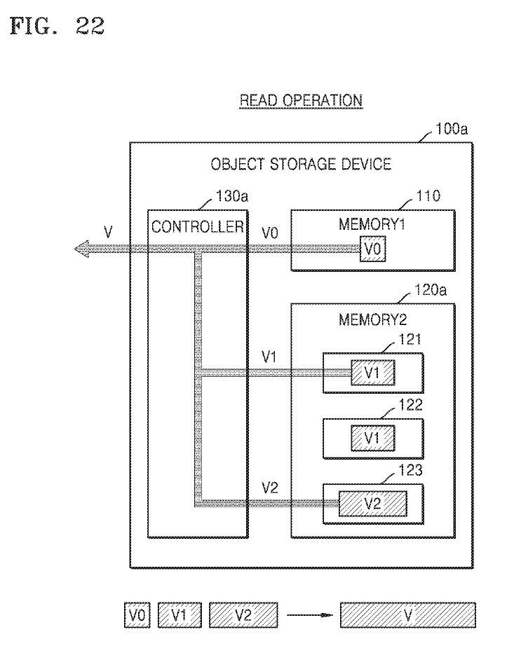

FIG. 22 illustrates a read operation with respect to the object storage device 100a shown in FIG. 20, according to an exemplary embodiment of the present inventive concept.

Referring to FIG. 22, the controller 130a may receive a key and may search for a storage address of a value V by using the received key. As a result of the search, when each of storage addresses of first, second, and third partial values V0, V1, and V2 corresponds to the first memory 110 or the second memory 120a, the controller 130a may control the first and second memories 110 and 120a to simultaneously perform read operations. In addition, the controller 130a may select one of the first and second storage spaces 121 and 122, based on states of the first and second storage spaces 121 and 122 of the second memory 120a, and may read the second partial value V1 from the selected storage space.

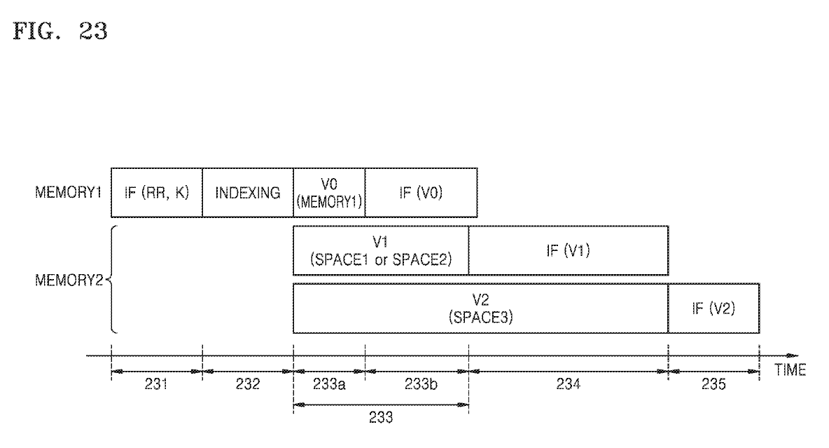

FIG. 23 illustrates a read operation according to time, the read operation being performed by the object storage device 100a shown in FIG. 20, according to an exemplary embodiment of the present inventive concept.

Referring to FIGS. 22 and 23, during a first period 231, the controller 130a may receive a read request RR and a key K from an external source. During a second period 232, the controller 130a may index a storage address of a value according to the key K, based on the key K. During a third period 233, read operations with respect to the first memory 110, the first storage space 121 or the second storage space 122 of the second memory 120a, and the third storage space 123 of the second memory 120a may be simultaneously performed.

The third period 233 may include a read period 233a and a transmission period 233b. During the read period 233a, a first partial value V0 may be read from the first memory. During the transmission period 233b, the read first partial value V0 may be transmitted to an external source. In addition, during the third period 233, a second partial value V1 may be read from the first storage space 121 or the second storage space 122 of the second memory 120a. During a fourth period 234, the read second partial value V1 may be transmitted to the external source. In addition, during the third period 233 and the fourth period 234, a third partial value V2 may be read from the third storage space 123 of the second memory 120a. During a fifth period 235, the read third partial value V2 may be transmitted to the external source.

According to the present embodiment, although a read period (in other words, the third period 233) with respect to the first storage space 121 or the second storage space 122 is longer than the read period 233a with respect to the first memory 110 by an additional time, the additional time for the first storage space 121 or the second storage space 122 may be hidden by the transmission period 233b. In addition, although a read period (in other words, the third period 233 and the fourth period 234) with respect to the third storage space 123 is longer than the third period 233 that is the read period with respect to the first storage space 121 or the second storage space 122 by an additional time, the additional time for the third storage space 123 may be hidden by the fourth period 234.

In addition, according to the present embodiment, the first partial value V0 may be transmitted to the external source during the transmission period 233b included in the third period 233, the second partial value V1 may be transmitted to the external source during the fourth period 234, and then, the third partial value V2 may be transmitted to the external source during the fifth period 235. Therefore, in view of an interface between the object storage device 100a and the host, the object storage device 100a may function such that it reads an entire value from the first memory 110 whose read speed is relatively fast.

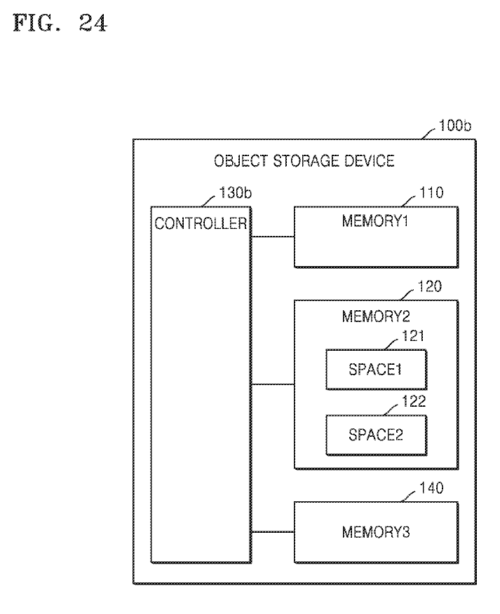

FIG. 24 is a block diagram of an object storage device 100b, according to an exemplary embodiment of the present inventive concept.

Referring to FIG. 24, the object storage device 100b is a modified example of the object storage device 100 of FIG. 2, and may include the first memory 110, the second memory 120, a third memory 140, and a controller 130b. The first memory 110, the second memory 120, and the third memory 140 may have a first latency, a second latency, and a third latency, respectively. Each of the second latency and the third latency may be greater than the first latency. In the present embodiment, the second latency and the third latency may be equal to each other, and the second and third memories 120 and 140 may be homogeneous memories. For example, the second and third memories 120 and 140 may be memories that are configured with different chips. In an exemplary embodiment of the present inventive concept, the second latency and the third latency may be different from each other, and the second and third memories 120 and 140 may be heterogeneous memories.

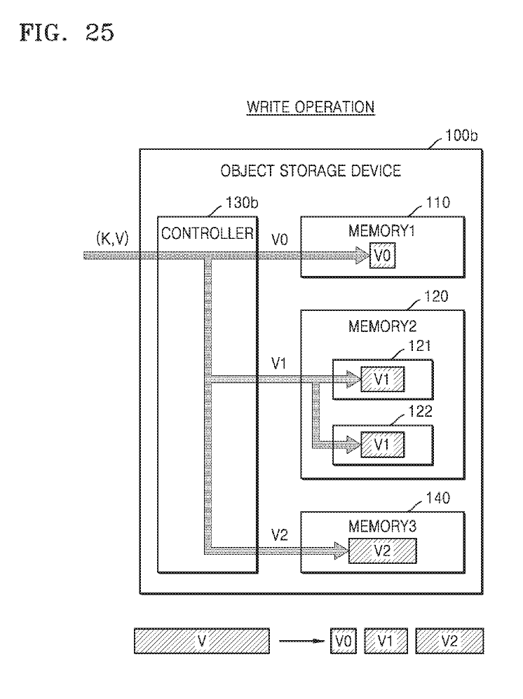

FIG. 25 illustrates an example of a write operation with respect to the object storage device 100b of FIG. 24, according to an exemplary embodiment of the present inventive concept.

Referring to FIG. 25, when a size of a value V is greater than a threshold value, the controller 130b may divide the value V into first, second, and third partial values V0, V1, and V2. Then, the controller 130b may control the first memory 110 to store the first partial value V0 in the first memory 110, and may store the second partial value V1 and the third partial value V2 respectively in the second memory 120 and the third memory 140 each having a relatively slow response speed.

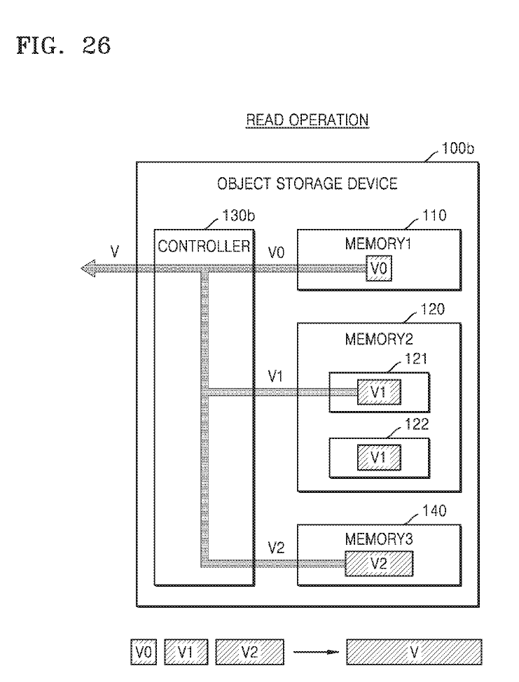

FIG. 26 illustrates a read operation with respect to the object storage device 100b of FIG. 24, according to an exemplary embodiment of the present inventive concept.

Referring to FIG. 26, when storage addresses of the first, second, and third partial values V0, V1, and V2 of the value V correspond to the first, second, and third memories 110, 120, and 140, respectively, the controller 130b may control the first, second, and third memories 110, 120, and 140 to simultaneously perform read operations with respect to the first, second, and third memories 110, 120, and 140. In addition, the controller 130b may select one of the first and second storage spaces 121 and 122, based on states of the first and second storage spaces 121 and 122 of the second memory 120, and may read the second partial value V1 from the selected storage space.

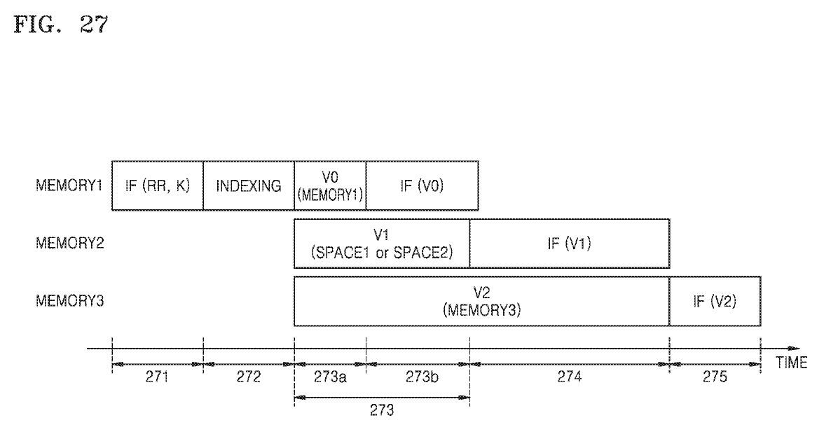

FIG. 27 illustrates a read operation according to time, the read operation being performed by the object storage device 100b shown in FIG. 24, according to an exemplary embodiment of the present inventive concept.

Referring to FIGS. 26 and 27, during a first period 271, the controller 130b may receive a read request RR and a key K from an external source. During a second period 272, the controller 130b may index a storage address of a value V according to the key K, based on the key K.

A third period 273 may include a read period 273a and a transmission period 273b. During the read period 273a, the first partial value V0 may be read from the first memory 110. During the transmission period 273b, the read first partial value V0 may be transmitted to the external source. In addition, during the third period 273, the second partial value V1 may be read from the first storage space 121 or the second storage space 122 of the second memory 120. During a fourth period 274, the read second partial value V1 may be transmitted to the external source. In addition, during the third period 273 and the fourth period 274, the third partial value V2 may be read from the third memory 140. During a fifth period 275, the read third partial value V2 may be transmitted to the external source.

According to the present embodiment, although a read period (in other words, the third period 273) with respect to the second memory 120 is longer than the read period 273a with respect to the first memory 110 by an additional time, the additional time for the second memory 120 may be hidden by the third period 273b. In addition, although a read period (in other words, the third period 273 and the fourth period 274) with respect to the third memory 140 is longer than the third period 273 that is the read period with respect to the second memory 120 by an additional time, the additional time for the third memory 140 may be hidden by the fourth period 274.

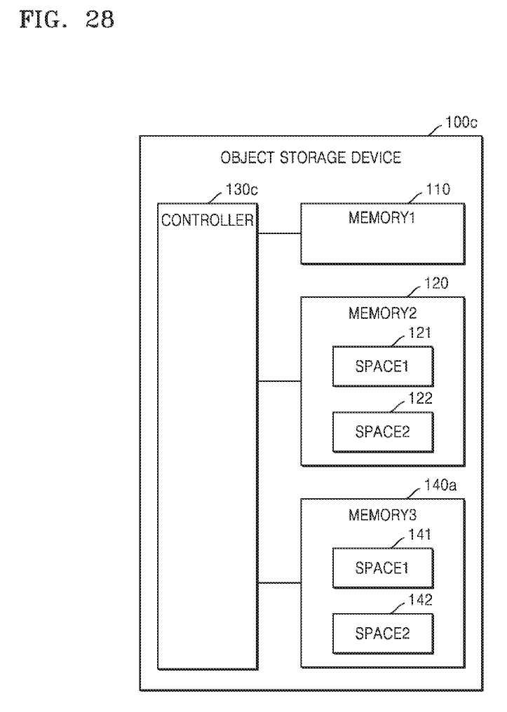

FIG. 28 is a block diagram of an object storage device 100c, according to an exemplary embodiment of the present inventive concept.

Referring to FIG. 28, the object storage device 100c is a modified example of the object storage device 100b of FIG. 24, and may include the first memory 110, the second memory 120, a third memory 140a, and a controller 130c. The third memory 140a may include first and second storage spaces 141 and 142. The first and second storage spaces 141 and 142 may be configured to duplicately store a third portion of an object. In an exemplary embodiment of the present inventive concept, the third memory 140a may further include a third storage space, and the third storage space may be configured to store a fourth portion of the object. In addition, in an exemplary embodiment of the present inventive concept, the third memory 140a may further include third and fourth storage spaces, and the third and fourth storage spaces may be configured to duplicately store the fourth portion of the object.

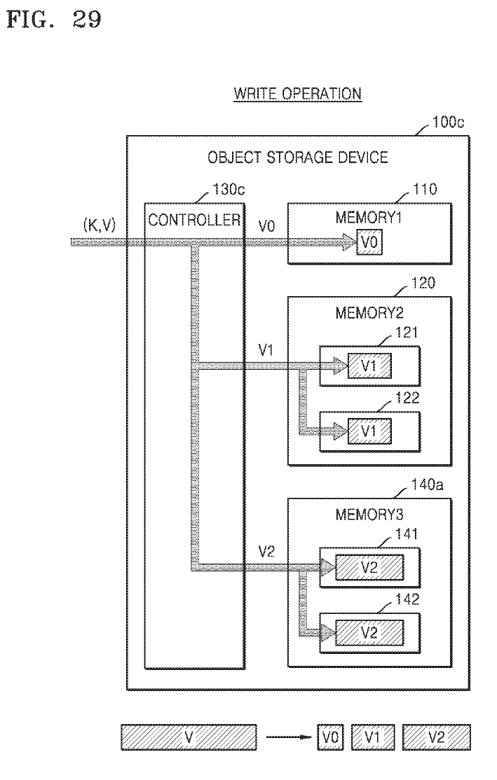

FIG. 29 illustrates an example of a write operation with respect to the object storage device 100c of FIG. 28, according to an exemplary embodiment of the present inventive concept.

Referring to FIG. 29, when a size of a value V is greater than a threshold value, the controller 130c may divide the value V into first, second, and third partial values V0, V1, and V2. Then, the controller 130c may store the first partial value V0 in the first memory 110 whose response speed is relatively fast, may duplicately store the second partial value V1 in the second memory 120 whose response speed is relatively slow, and may duplicately store the third partial value V2 in the third memory 140a whose response speed is relatively slow.

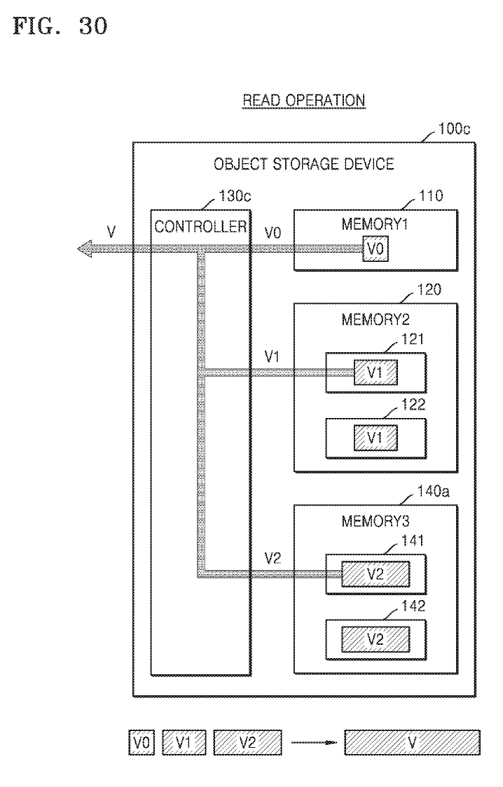

FIG. 30 illustrates a read operation with respect to the object storage device 100c of FIG. 28, according to an exemplary embodiment of the present inventive concept.

Referring to FIG. 30, when storage addresses of the first, second, and third partial values V0, V1, and V2 of the value V correspond to the first, second, and third memories 110, 120, and 140a, respectively, the controller 130c may control the first, second, and third memories 110, 120, and 140a to simultaneously perform read operations. In this case, the controller 130c may select a storage space in an idle state, the storage space being from among the first and second storage spaces 121 and 122 of the second memory 120. In addition, the controller 130c may select a storage space in an idle state, the storage space being from among the first and second storage spaces 141 and 142 of the third memory 130.

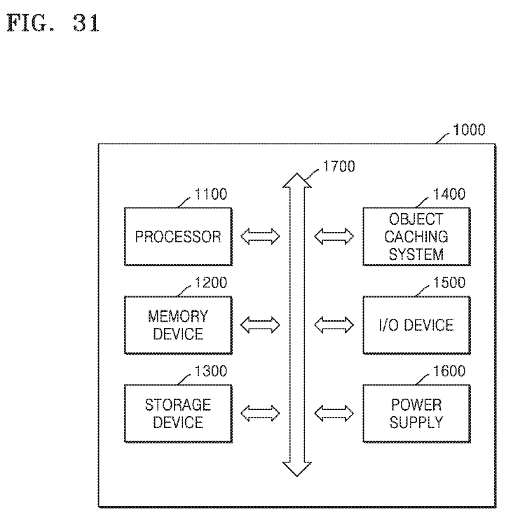

FIG. 31 is a block diagram of a computing system 1000, according to an exemplary embodiment of the present inventive concept.

Referring to FIG. 31, the computing system 1000 may include a processor 1100, a memory device 1200, a storage device 1300, an object caching system 1400, an input/output (I/O) device 1500, and a power supply 1600. In the present embodiment, the object caching system 1400 may include one of object storage devices 100, 100a, 100b, and 100c according to at least one of the exemplary embodiments described above. For example, the object caching system 1400 may include a first memory having a first latency, and a second memory having a second latency greater than the first latency. The object caching system 1400 may simultaneously perform read operations with respect to the first and second memories, and while the object caching system 1400 transmits data read from the first memory whose response speed is fast, the object caching system 1400 may keep performing the read operation with respect to the second memory whose response speed is slower than the first memory. For example, the object cache server device OCS illustrated in FIG. 1 may be implemented as the computing system 1000.

While the present inventive concept has been particularly shown and described with reference to exemplary embodiments thereof, it will be understood that various changes in form and details may be made therein without departing from the spirit and scope of the inventive concept as defined by the following claims.

1. A controller, comprising:
an interface unit configured to receive an access request for object data; and
an indexing unit configured to determine whether to divide the object data and, when the object data is divided, store a first portion of the object data in a first memory and a second portion of the object data in a first storage space and a second storage space,
wherein the first and second storage spaces have a latency greater than a latency of the first memory.

2. The controller of claim 1, wherein the access request is a write request or a read request.

3. The controller of claim 1, wherein the indexing unit is configured to divide the object data according to a condition.

4. The controller of claim 3, wherein the condition includes a threshold value, information about the first memory, information about the first and second storage spaces, a number of times the object data has been accessed, a power operation mode of the controller, or a priority of a dividing operation.

5. The controller of claim 4, wherein the indexing unit is configured to determine the threshold value, and divide the object data by using the threshold value.

6. The controller of claim 5, wherein the threshold value is determined by using a bandwidth of the first memory and a read time of the first memory.

7-13. (canceled)

14. The controller of claim 1, wherein the indexing unit is configured to determine storage addresses of the first or second storage spaces in die units, plane units, or chip units.

15. The controller of claim 1, wherein the controller is configured to select one of the first or second storage spaces in a read operation based on a state of each of the first and second storage devices.

16-17. (canceled)

18. A nonvolatile memory storage device, comprising:
a first memory having a first latency;
first and second storage spaces having a second latency greater than the first latency; and
a controller configured to determine whether to divide object data in response to an access request of the object data and, when the object data is divided into first and second portions, store the first portion in the first memory and the second portion in the first and second storage spaces.

19. The nonvolatile memory storage device of claim 18, further comprising a third storage space, and when the object data is divided to have a third portion, the third portion is stored in the third storage space.

20. The nonvolatile memory storage device of claim 19, wherein the first to third storage spaces are respectively disposed in first, second, and third dies.

21. The nonvolatile memory storage device of claim 19, wherein the first to third storage spaces are respectively disposed in first, second, and third memory planes.

22. The nonvolatile memory storage device of claim 19, wherein the first to third storage spaces are respectively disposed in first, second, and third memory blocks.

23. The nonvolatile memory storage device of claim 18, wherein the first and second storage spaces are included in a second memory.

24-26. (canceled)

27. The nonvolatile memory storage device of claim 18, wherein the controller is configured to divide the data object according to a condition.

28. The nonvolatile memory storage device of claim 27, wherein the condition includes a threshold value, information about the first memory, information about the first and second storage spaces, a number of times the object data has been accessed, a power operation mode of the controller, or a priority of a dividing operation.

29. (canceled)

30. A write method, comprising:
receiving a write request and object data;
dividing the object data into first and second partial values when a size of the object data is greater than a threshold value;
storing the first partial value in a first memory having a first latency;
storing the second partial value sequentially in first and second storage spaces,
wherein each of the first and second storage spaces has a second latency greater than the first latency.

31. The method of claim 30, Wherein the first partial value is a head portion of the object data and the second partial value is a tail portion of the object data.

32. The method of claim 30, wherein when the object data is further divided to have a third partial value, the third partial value is stored in a third storage space.

33. The method of claim 30, further comprising storing all of the object data in the first memory when the size of the object data is equal to or less than the threshold value.

34-41. (canceled)
